(19) United States
(12) Patent Application Publication
(10) Pub. No.: US 2022/0020275 A1
(43) Pub. Date: Jan. 20, 2022

(54) VEHICLE DISPATCH SYSTEM, INFORMATION PROCESSING APPARATUS, AND VEHICLE DISPATCH PROCESSING METHOD

(71) Applicant: TOYOTA JIDOSHA KABUSHIKI KAISHA, Toyota-shi (JP)

(72) Inventors: Yurika TANAKA, Yokosuka-shi (JP); Shoji SAKAMOTO, Ichikawa-shi (JP); Kenichi YAMADA, Nisshin-shi (JP); Yuko MIZUNO, Nagoya-shi (JP); Hiromitsu FUJII, Kariya-shi (JP); Katsuhiro OHARA, Nagoya-shi (JP)

(73) Assignee: TOYOTA JIDOSHA KABUSHIKI KAISHA, Toyota-shi (JP)

(21) Appl. No.: 17/378,040

(22) Filed: Jul. 16, 2021

(30) Foreign Application Priority Data
Jul. 17, 2020 (JP) 2020-122984

(51) Int. Cl. G08G 1/00; G01C 21/36; B60W 60/00; G06Q 50/30

(52) U.S. Cl. CPC G08G 1/202; G06Q 50/30; B60W 60/00253; G01C 21/3679

(57) ABSTRACT

A vehicle dispatch system includes a plurality of vehicles and an information processing apparatus. The plurality of vehicles is configured to drive autonomously in accordance with a driving plan. The information processing apparatus is configured to acquire a product collection request including user identification information and shop identification information to generate the driving plan based on the user identification information and the shop identification information, the user identification information identifying a user, the shop identification information identifying at least one shop at which the user has purchased a product, and the driving plan specifying a driving route passing through the at least one shop at which the user has purchased the product. Upon receiving a vehicle dispatch start request, the information processing apparatus establishes the driving plan and transmits the driving plan to a selected vehicle that is selected from the plurality of vehicles.

### CROSS-REFERENCE TO RELATED APPLICATION

This application claims priority to Japanese Patent Application No. 2020-122984, filed on Jul. 17, 2020, the entire contents of which are incorporated herein by reference.

### TECHNICAL FIELD

The present disclosure relates to a vehicle dispatch system, an information processing apparatus, and a vehicle dispatch processing method.

### BACKGROUND

Shopping assist systems have been proposed to enable, when users select products that they wish to purchase through user terminals in advance, the users to acquire the products by automatically determining suppliers and causing vehicles to tour shops as the suppliers along optimal routes (for example, Patent Literature [PTL] 1).

### CITATION LIST

### Patent Literature

PTL 1: JP 2018-063660 A

### SUMMARY

According to the shopping assist systems, a user needs to create their list of products to be purchased before actually going shopping and to go around shops along a predetermined route. The user, however, may wish to freely enjoy shopping itself. For example, sometimes the user wants to freely stroll around the shops without carrying purchased products while shopping and collect the purchased products with no difficulty when the shopping is finished.

It would be helpful to provide a vehicle dispatch system, an information processing apparatus, and a vehicle dispatch processing method that allow collection of purchased products while flexibly addressing purchase behavior of users.

A vehicle dispatch system according to an embodiment of the present disclosure includes a plurality of vehicles and an information processing apparatus. The plurality of vehicles is configured to drive autonomously in accordance with a driving plan. The information processing apparatus is configured to acquire a product collection request including user identification information and shop identification information to generate the driving plan based on the user identification information and the shop identification information, the user identification information identifying a user, the shop identification information identifying at least one shop at which the user has purchased a product, and the driving plan specifying a driving route passing through the at least one shop at which the user has purchased the product. Upon receiving a vehicle dispatch start request, the information processing apparatus establishes the driving plan and transmits the driving plan to a selected vehicle that is selected from the plurality of vehicles.

An information processing apparatus according to an embodiment of the present disclosure includes a communication interface and a controller. The communication interface is configured to acquire a product collection request including user identification information and shop identification information, the user identification information identifying a user, and the shop identification information identifying at least one shop at which the user has purchased a product. The controller is configured to generate a driving plan that specifies a driving route passing through the at least one shop at which the user has purchased the product based on the user identification information and the shop identification information. Upon receiving a vehicle dispatch start request via the communication interface, the controller establishes the driving plan and transmits the driving plan via the communication interface to a selected vehicle that is selected from a plurality of vehicles configured to drive autonomously in accordance with the driving plan.

A vehicle dispatch processing method according to an embodiment of the present disclosure includes acquiring a product collection request including user identification information and shop identification information, the user identification information identifying a user, and the shop identification information identifying at least one shop at which the user has purchased a product. The vehicle dispatch processing method includes generating a driving plan that specifies a driving route passing through the at least one shop at which the user has purchased the product based on the user identification information and the shop identification information. The vehicle dispatch processing method includes, upon receiving a vehicle dispatch start request, establishing the driving plan and transmitting the driving plan to a selected vehicle that is selected from a plurality of vehicles configured to drive autonomously in accordance with the driving plan.

According to an embodiment of the present disclosure, purchased products can be collected while purchase behavior of users is flexibly addressed.

### BRIEF DESCRIPTION OF THE DRAWINGS

In the accompanying drawings:

FIG. 1 schematically illustrates a configuration of a vehicle dispatch system according to an embodiment;

FIG. 2 is a block diagram schematically illustrating an example configuration of an information processing apparatus of FIG. 1;

FIG. 3 is a block diagram schematically illustrating an example configuration of a vehicle of FIG. 1;

FIG. 4 is a block diagram schematically illustrating an example of an in-store system including a shop computer of FIG. 1;

FIG. 5 is a sequence diagram illustrating an example flow of information transmitted and received between the components of the vehicle dispatch system of FIG. 1 before collection of products is started;

FIG. 6 illustrates an example of a driving plan generated by the information processing apparatus;

FIG. 7 is a sequence diagram illustrating an example flow of information transmitted and received between the components of the vehicle dispatch system of FIG. 1 during the collection of the products;

FIG. 8 is a flowchart illustrating an example of vehicle dispatch processing executed by the information processing apparatus;

FIG. 9 is a sequence diagram illustrating a flow of information transmitted and received between the components of the vehicle dispatch system of FIG. 1 in a case in which collection of products is started before purchase of the products is finished; and

FIG. 10 is a flowchart illustrating an example of vehicle dispatch processing executed by the information processing apparatus when the collection of the products is started before the purchase of the products is completed.

### DETAILED DESCRIPTION

The following describes embodiments of the present disclosure with reference to the drawings. The drawings used in the following description are schematic. Dimensional ratios or the like on the drawings do not necessarily match actual ones.

### Overall Configuration of Vehicle Dispatch System

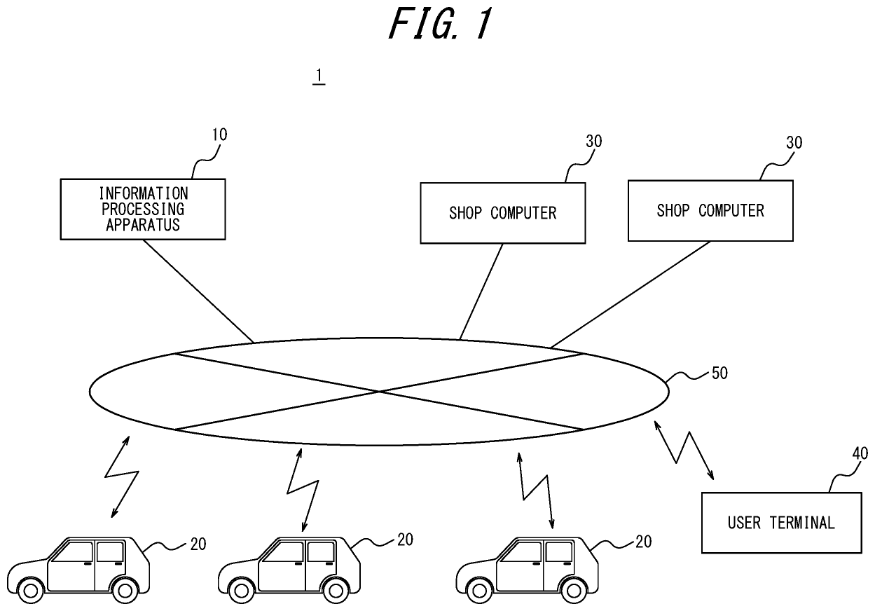

As illustrated in FIG. 1, a vehicle dispatch system 1 according to the embodiment of the present disclosure includes an information processing apparatus 10 and a plurality of vehicles 20. The information processing apparatus 10 and the plurality of vehicles 20 are configured to communicate with each other via a network 50. The information processing apparatus 10 may be connected to a relay base station on the network 50 via a wired or wireless line. The plurality of vehicles 20 may be connected to relay base stations on the network 50 via respective wireless communication lines. The network 50 may include the Internet, a Virtual Private Network (VPN), telephone lines, and the like.

The vehicle dispatch system 1 may further include shop computers 30. The shop computers 30 are computers installed in shops at which users can purchase products. The shop computers 30 are used for sales processing for products in the shops. The shop computers 30 are included in in-store systems. The shop computers 30 may be connected to relay base stations on the network 50 via wired or wireless lines.

The information processing apparatus 10 is configured to transmit and receive information to and from a user terminal 40 in the possession of a user who uses the vehicle dispatch system 1 via the network 50. The vehicles 20 and the shop computers 30 may be configured to transmit and receive information to and from the user terminal 40 via the network 50.

### Configuration of Information Processing Apparatus

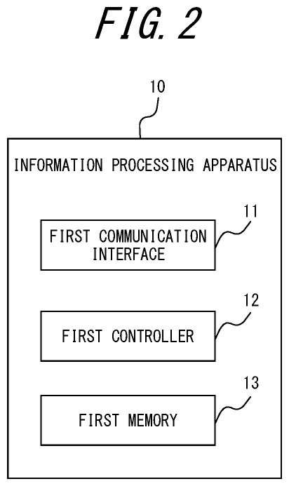

As illustrated in FIG. 2, the information processing apparatus 10 according to the embodiment of the present disclosure includes a first communication interface 11, a first controller 12, and a first memory 13. The information processing apparatus 10 is not limited to a single type of hardware, and may be configured by a plurality of types of hardware connected by a Local Area Network (LAN) or the like. Further, a plurality of types of hardware equipped with the functions of the information processing apparatus 10 can be arranged in a geographically distributed manner via the network 50.

The first communication interface 11 includes a communication module connected to the network 50. The communication module may include communication modules compliant with various communication standards, such as wired LANs, wireless LANs, optical communication lines, or digital subscriber lines. The first communication interface 11 can perform processing, such as protocol processing pertaining to information transmission and receipt, modulation of transmitted signals, or demodulation of received signals. In the present embodiment, the information processing apparatus 10 is connected to the network 50 via the first communication interface 11.

The first controller 12 includes a single processor or a plurality of processors. In the present disclosure, processors include general purpose processors that execute programmed functions by loading a program, and dedicated processors that are dedicated to specific processing. Dedicated processors may include Digital Signal Processors (DSPs), Application Specific Integrated Circuits (ASICs), Field-Programmable Gate Arrays (FPGAs), and the like. The first controller 12 may further include a memory.

The first controller 12 controls operations of the entire information processing apparatus 10. The processing executed by the information processing apparatus 10 can be referred to as the processing executed by the first controller 12. The first controller 12 can transmit and receive information to and from the vehicles 20, the shop computers 30, and the user terminal 40, via the first communication interface 11. The first controller 12 can receive, via the first communication interface 11 from each shop computer 30, a product collection request pertaining to purchase of one or more products by the user. The first controller 12 can acquire a current location of each vehicle 20, by transmitting and receiving information to and from each vehicle 20 via the first communication interface 11. The first controller 12 can transmit, to each vehicle 20, a driving plan including a corresponding route along which each vehicle 20 should drive, via the first communication interface 11. The first controller 12 can calculate an optimal route for collecting the products purchased by the user and delivering the products to a destination.

The first memory 13 stores any information used for the operations of the information processing apparatus 10. The first memory 13 may include a semiconductor storage apparatus, a magnetic storage apparatus, and an optical storage apparatus. Semiconductor storage apparatuses may include memories, such as Read Only Memory (ROM), Random Access Memory (RAM), or flash memory. The first memory 13 may store user identification information that identifies users and location information for a corresponding registered destination of each user. The first memory 13 may store location information for each shop. The first memory 13 may store information regarding sizes, specifications, or the like of the plurality of vehicles 20.

### Configuration of Vehicle

Each vehicle 20 is a vehicle that collects one or more products purchased by the user at one or more shops and delivers the products to the destination. The destination may be registered in advance by the user. The destination is, for example, a home of the user. Each vehicle 20 may be a vehicle that people, along with the products, can board. Each vehicle 20 may be a small-sized vehicle dedicated to delivery. The plurality of vehicles 20 may include a plurality of vehicles with different sizes, such as large and small. The plurality of vehicles 20 may include a plurality of vehicles with different specifications, such as with refrigerators or with freezers.

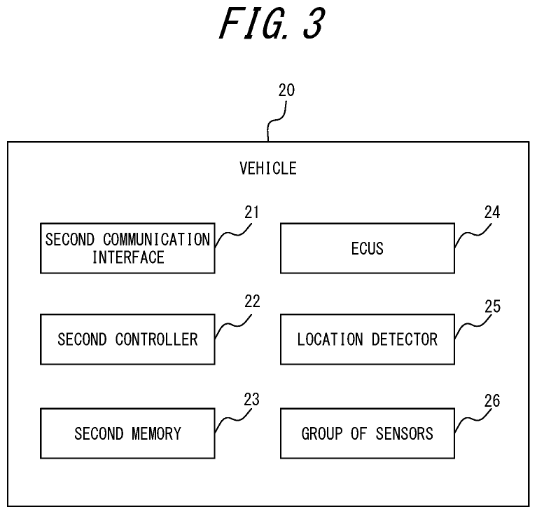

As illustrated in FIG. 3, each vehicle 20 includes a second communication interface 21, a second controller 22, a second memory 23, ECUs 24, a location detector 25, and a group of sensors 26. The components of each vehicle 20 are communicably connected to each other via a network in each vehicle 20, such as a Controller Area Network (CAN).

The second communication interface 21 includes a communication module that is connected to the network 50 and communicates with the information processing apparatus 10. The second communication interface 21 may include a communication module that communicates with the shop computers 30. The communication module includes, but is not limited to, a communication module compatible with mobile communication standards, such as the 4th Generation (4G) standard or the 5th Generation (5G) standard. The second communication interface 21 may include a communication module that communicates with the user terminal 40. The second communication interface 21 may communicate with the user terminal 40 via the network 50. The second communication interface 21 may include a communication module that directly communicates with the user terminal 40 using short-range wireless communication.

The second controller 22 controls an entire vehicle 20. The processing executed by the vehicle 20 can be referred to as the processing executed by the second controller 22. The second controller 22 includes a single processor or a plurality of processors and a memory, as is the case described for the first controller 12. The second controller 22 controls driving of the vehicle 20 in accordance with an instruction received from the information processing apparatus 10 via the second communication interface 21. The second controller 22 enables the vehicle 20 to drive autonomously, in cooperation with the ECUs 24, the location detector 25, and the group of sensors 26. The autonomous driving may include, for example, any level from Level 1 to Level 5 as defined by the Society of Automotive Engineers (SAE), but is not limited to these, and may be defined in any way. In the present embodiment, the vehicle 20 will be described as being capable of driverless autonomous driving (e.g., Level 5 autonomous driving defined by the SAE).

Based on the instruction from the information processing apparatus 10, the second controller 22 controls the components of the vehicle 20, including the ECUs 24, to autonomously drive along a route as instructed by the information processing apparatus 10. Based on the instruction from the information processing apparatus 10, the second controller 22 can cause the vehicle 20 to drive to the destination while passing through the at least one shop. Based on the instruction from the information processing apparatus 10, the second controller 22 may cause the vehicle 20 to travel to a predetermined boarding location so as to let the user board at the predetermined boarding location.

The second memory 23 stores any information used for operations of the vehicle 20. The second memory 23 may include various storage apparatuses, as is the case described for the first memory 13. The second memory 23 may store information regarding a road map. The second memory 23 may store the driving plan that has been received from the information processing apparatus 10.

The ECUs 24 are a plurality of Electronic Control Units (ECUs) that control respective pieces of equipment in the vehicle 20. The equipment in the vehicle 20 related to the ECUs 24 includes, but is not limited to, an engine, a motor, a brake, a transmission, a navigational system, or the like. The ECUs 24 are connected with each other via a network, such as the Controller Area Network (CAN).

The location detector 25 detects the location of the vehicle 20. The location of the vehicle 20 may be detected as an absolute location defined by a latitude and longitude, etc. The location detector 25 may include various detecting apparatuses, including a receiving apparatus compliant with Global Navigation Satellite System (GNSS), an orientation sensor, a steering angle sensor, and a range sensor. A GNSS can measure the location of the vehicle 20 using satellites. By using a signal from a GNSS receiving apparatus, information regarding the latitude and longitude at the current location of the vehicle 20 can be acquired. As the receiving apparatus compliant with the GNSS, a Global Positioning System (GPS) receiving apparatus may be employed. The location detector 25 may also employ a receiving apparatus compliant with a different GNSS, instead of the GPS receiving apparatus or in addition to the GPS receiving apparatus. The different GNSS includes, for example, a satellite positioning system using quasi-zenith satellites. The orientation sensor, the steering angle sensor, and the range sensor can be used to assist in location detection using the GNSS.

The group of sensors 26 includes various sensors mounted on the vehicle 20. The group of sensors 26 is interconnected with the ECUs 24 and can be used for driving control. The sensors included in the group of sensors 26 used for driving control include, but are not limited to, a vehicle speed sensor, an acceleration sensor, a brake sensor, a sensor for forward distance between vehicles, a sensor for backward distance between vehicles, a driving lane detection sensor, an image sensor, or the like.

### Configuration of Shop System

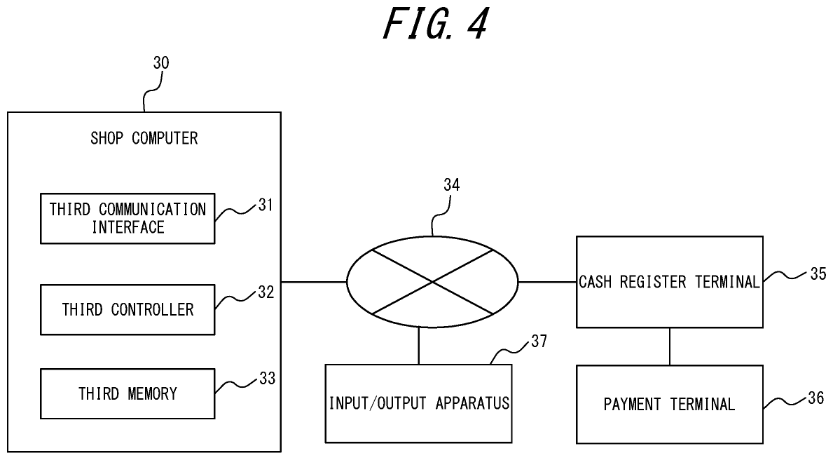

As illustrated in FIG. 4, for example, a system in a shop including a shop computer 30 includes the shop computer 30, a plurality of cash register terminals 35, and an input/output apparatus 37 that are connected by an in-store network 34. A corresponding payment terminal 36 is connected to each cash register terminal 35. The corresponding payment terminal 36 may be integrated with each cash register terminal 35. As the in-store network 34, wired and wireless LANs can be used.

The shop computer 30 is configured to accept, from the user, selection of delivery or pickup of one or more products. The shop computer 30 is configured to, upon accepting, from the user, selection of delivery, transmit, to the information processing apparatus 10, user identification information that identifies the user and shop identification information that identifies the shop. The shop computer 30 includes a third communication interface 31, a third controller 32, and a third memory 33.

The third communication interface 31, as is the case with the first communication interface 11, includes a communication module for connection with the network 50. In the present embodiment, the shop computer 30 is connected to the network 50 via the third communication interface 31. The third communication interface 31 further includes a communication module for connection with the in-store network 34. The shop computer 30 is connected to the in-store network 34 via the third communication interface 31.

The third controller 32, as is case with the first controller 12, includes a single processor or a plurality of processors. The third controller 32 controls operations of the entire shop computer 30. The processing executed by the shop computer 30 can be referred to as processing executed by the third controller 32. The third controller 32 can transmit and receive information to and from the cash register terminals 35 and the input/output apparatus 37, via the third communication interface 31. The third controller 32 can transmit and receive information to and from the information processing apparatus 10 and the vehicles 20, via the third communication interface 31.

The third memory 33 stores any information used for the operations of the shop computer 30. The third memory 33, as is case with the first memory 13, may include a semiconductor storage apparatus, a magnetic storage apparatus, and an optical storage apparatus.

Each cash register terminal 35 is a terminal for registering and checking out one or more products to be purchased by the user at the shop. For example, each cash register terminal 35 may include an apparatus that reads bar codes, IC tags, or the like attached to products, thereby being capable of identifying the products to be purchased by the user. Each cash register terminal 35 may cooperate with the shop computer 30 so as to calculate a total amount of thus identified products and perform payment processing with the user.

The corresponding payment terminal 36 is connected to each cash register terminal 35 by a wired/wireless LAN, a USB cable, an RS232C cable, or the like. When the payment processing for the product is performed, the payment terminal 36 can acquire information from, or can transmit and receive information to and from the user terminal 40 in the possession of the user. The information may be transmitted and received between the payment terminal 36 and the user terminal 40, using a short-range communication means, such as Near Field Communication (NFC), Bluetooth® (Bluetooth is a registered trademark in Japan, other countries, or both), or the like, or using an optical method. The payment terminal 36 can acquire, from the user terminal 40, the user identification information that identifies the user when the user makes the payment using the user terminal 40. The payment terminal 36 may perform the payment processing with another medium instead of the user terminal 40, such as an IC card having the user identification information.

The input/output apparatus 37 displays information under the control of the shop computer 30. The input/output apparatus 37 accepts an input to the shop computer 30. The input/output apparatus 37 includes, for example, a liquid crystal display with a touch panel. The input/output apparatus 37 displays an instruction for loading one or more products to a vehicle 20 at, for example, a product shipment location, and accepts an input indicating completion of the loading of the products.

### User Terminal

The user terminal 40 is an information terminal including an input/output interface, an information processor, a communication interface, a location detector, and a memory. As the user terminal 40, for example, a general-purpose portable information terminal, such as a smartphone, can be used. The input/output interface includes, for example, a liquid crystal display with a touch panel. The user terminal 40 can accept an input from the user using the input/output interface and display, to the user, information processed by the information processor. The information processor includes a processor. The information processor executes various types of information processing in the user terminal 40. The communication interface includes, for example, a wireless communication module compatible with a communication method for the network 50. The user terminal 40 can communicate with the information processing apparatus 10 via the network 50 using the communication interface. The user terminal 40 may communicate with the vehicles 20 via the network 50. The location detector of the user terminal 40 includes a GPS receiver and is capable of detecting the location of the user terminal 40 itself.

The user terminal 40 can run an application for using the service provided by the vehicle dispatch system 1. In accordance with the application, the user terminal 40 can handle input of information from the user, output of information to the user, and transmission and receipt of information to and from the information processing apparatus 10 and the vehicles 20. The user can acquire the application from an operator providing a vehicle dispatch service.

The user terminal 40 stores, in the memory, user identification information required when using the vehicle dispatch service. The user terminal 40 can transmit or present the user identification information to the payment terminal 36. The user terminal 40 may provide a payment function for performing payment processing at the time of product purchase, in cooperation with another payment system. The user terminal 40 may include a means for communicating with the vehicles 20 without using the network 50. The user terminal 40 may communicate directly with a vehicle 20 when the user boards the vehicle 20 and transmit and receive information for verifying whether the vehicle 20 is a vehicle 20 allocated to the user.

### Flow of Information up to Generation of Driving Plan

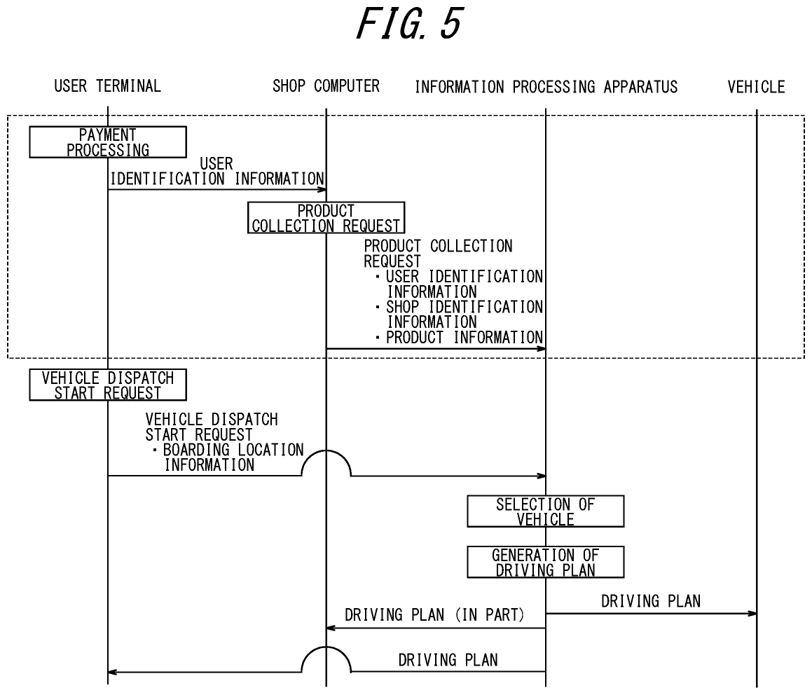

FIG. 5 illustrates an example flow of information between the components that occurs from purchase of products by the user to generation of a driving plan by the information processing apparatus 10.

It is assumed that the user can freely go around shops and enjoy shopping. When purchasing products, the user may select whether to carry the purchased products or request delivery of the products using the vehicle dispatch system according to the present embodiment. FIG. 5 illustrates a case in which the user selects delivery of the products.

When the user purchases one or more products at a shop, a shop computer 30 acquires user identification information acquired by a payment terminal 36 via a cash register terminal 35 and an in-store network 34 upon completion of payment processing with the user terminal 40. The shop computer 30 transmits, to the information processing apparatus 10, a product collection request including the user identification information and shop identification information that identifies the shop that the shop computer 30 belongs to. The product collection request may further include product information related to the products purchased by the user. The product information may include product names, product sizes, information related to precautions for product transportation, or the like. The information related to precautions for transportation may include information such as keep refrigerated, keep frozen, or fragile.

The product collection request may be transmitted directly from the user terminal 40 to the information processing apparatus 10 without using the shop computer 30. In this case, the third controller 32 of the shop computer 30 may receive, via the third communication interface 31, information indicating that the product collection request has been transmitted from the user terminal 40 to the information processing apparatus 10. It is stored in the third memory 33 of the shop computer 30 that a vehicle 20 is to collect the products later.

The product collection request may be transmitted from both the shop computer 30 and the user terminal 40 to the information processing apparatus 10. The information processing apparatus 10 may collate the user identification information acquired from the shop computer 30 with the user identification information acquired from the user terminal 40 so as to confirm that there is no error in the product collection request.

Upon acquiring the product collection request, the information processing apparatus 10 stores, in the first memory 13, the user identification information, the shop identification information, and the product information. The user can go around a plurality of shops to purchase products. Therefore, the processing illustrated in an area of FIG. 5 that is surrounded by a dash line can be repeated a plurality of times with varying shops.

On completion of purchasing the products, the user requests that vehicle dispatch be started using the user terminal 40. The user may desire that the user himself or herself is to board the vehicle 20, in which the products are to be collected, to return home. In that case, a vehicle dispatch start request that includes boarding location information indicating a boarding location at which the user is to board the vehicle 20 is transmitted from the user terminal 40 to the information processing apparatus 10. In a case in which the user does not desire to board the vehicle 20, a vehicle dispatch start request that does not include boarding location information is transmitted to the information processing apparatus 10.

Upon receiving the vehicle dispatch start request, the information processing apparatus 10 selects, from the plurality of vehicles 20, a vehicle 20 that is to be allocated for collecting the products purchased by the user, based on product collection requests from individual shops stored in the first memory 13. The vehicle 20 may be selected based on product information for the products purchased by the user. For example, the size of the vehicle 20 to be selected may be determined from the sizes of the products and the total number of the products as included in the product information. For example, a vehicle 20 with refrigeration equipment may be selected based on information related to precautions for transportation included in the product information. The vehicle 20 may be selected based on the respective current locations of the plurality of vehicles 20. The vehicle selected by the information processing apparatus 10 is also referred to as a selected vehicle.

The information processing apparatus 10 generates and establishes a driving plan including a driving route. The information processing apparatus 10 may select a driving route starting at the current location of the selected vehicle 20, passing through at least one shop at which one or more products are to be collected, and terminating at a predetermined destination, based on a driving distance. For example, the information processing apparatus 10 selects the driving route with the shortest driving distance. The predetermined destination can be a corresponding location that is specified in advance for each user and stored in the first memory 13. The predetermined destination may be stored in the first memory 13 in association with the user identification information. The predetermined destination is, for example, the home of the user.

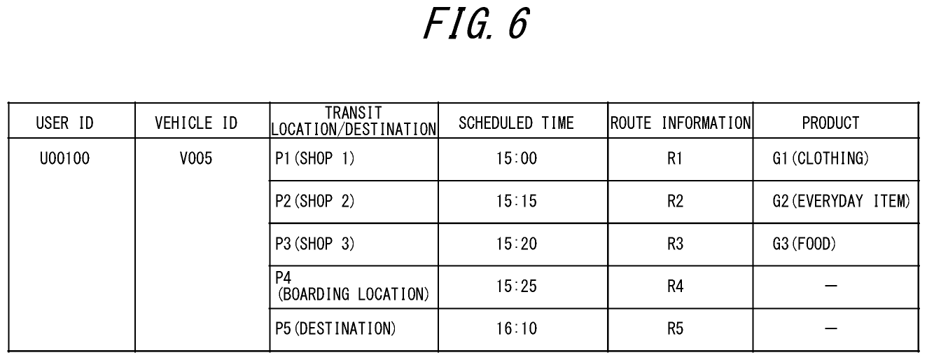

As illustrated in FIG. 6, for example, the driving plan is generated for each user and a corresponding vehicle allocated to each user. The driving plan includes location information for one or more transit locations and destination. For example, the location information may include, for each shop, latitude and longitude information indicating the location of the shop. For example, the driving plan may include respective scheduled arrival times at the transit locations and at the destination. For example, the driving plan may include route information from each transit location to the next transit location or to the destination. The route information may include, for example, information regarding roads to drive, intersections to pass through, or the like. The driving plan may also include information regarding the respective products to be collected at the transit locations.

The information processing apparatus 10 may select the driving route based on an estimated driving time period. For example, the information processing apparatus 10 selects the driving route with the shortest driving time period. The information processing apparatus 10 may estimate the driving time period based on speed limits on the roads included in the driving route. Further, the information processing apparatus 10 may estimate the driving time period, based on current congestion information on the roads, information regarding an average driving time period for the roads that is obtained from past information, or the like.

In a case in which the information processing apparatus 10 acquires boarding location information indicating a boarding location at which the user is to board, together with the vehicle dispatch start request, the information processing apparatus 10 includes the boarding location in the driving route of the driving plan. For example, the information processing apparatus 10 may generate a driving route to pass through the boarding location at which the user is to board after passing through each shop at which one or more products have been purchased.

The information processing apparatus 10 may select the vehicle and generate the driving plan concurrently rather than in series. The information processing apparatus 10 may be configured to select an optimal vehicle 20 and an optimal driving plan simultaneously.

The information processing apparatus 10 transmits the established driving plan to the selected vehicle 20. Thereafter, the selected vehicle 20 collects the products by autonomous driving in accordance with the driving plan. The information processing apparatus 10 may also transmit at least part of the information included in the driving plan to each shop computer 30. For example, each shop computer 30 can acquire the user identification information, the arrival times, and the product information from the information processing apparatus 10. Thus, each shop computer 30 can be informed in advance of when the vehicle 20 is to arrive and which products are to be collected by the vehicle 20. The information processing apparatus 10 may further transmit the driving plan to the user terminal 40.

### Flow of Information During Collection of Products

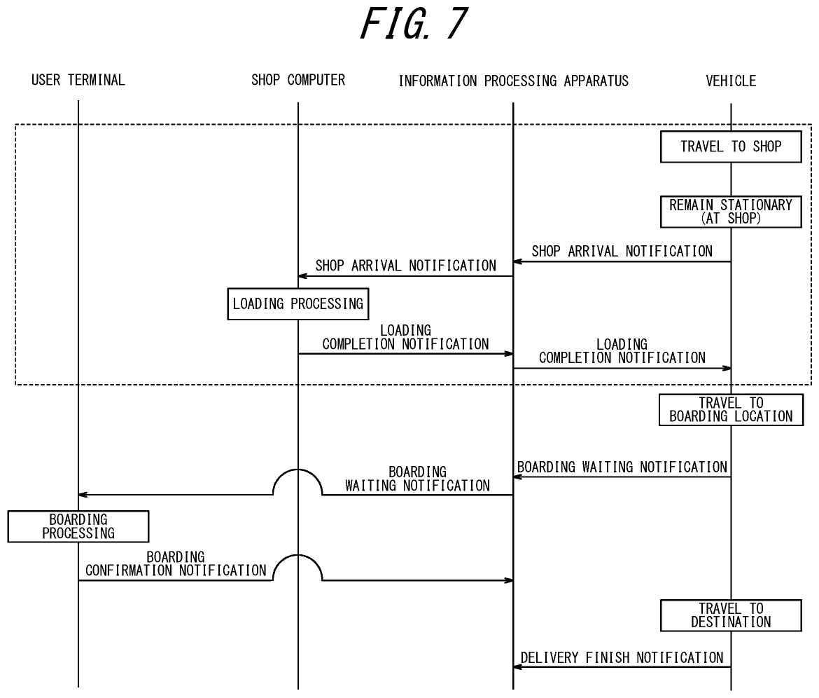

FIG. 7 illustrates an example flow of information at the time of collecting the products using the selected vehicle 20.

Upon receiving the driving plan, the vehicle 20 travels toward a shop, which is a transit location, in accordance with the driving plan. Upon arrival at the shop, the vehicle 20 remains stationary at a predetermined location in the vicinity of the shop. The vehicle 20 transmits, to a shop computer 30, a shop arrival notification including information indicating that the vehicle 20 has arrived at the shop, either via the information processing apparatus 10, or directly without using the information processing apparatus 10.

Upon receiving the shop arrival notification, the shop computer 30 causes the input/output apparatus 37 to present a display that prompts loading of products into the vehicle 20. A shop clerk checks the display on the input/output apparatus 37 and loads one or more products purchased by the user into the vehicle 20. When the loading is completed, the shop clerk makes an input indicating the completion of the loading at the input/output apparatus 37. Thus, the shop computer 30 transmits, to the vehicle 20, a loading completion notification indicating that the loading of the products is finished, either via the information processing apparatus 10 or directly without using the information processing apparatus 10. Note that the loading of the products at the shop may be, instead of performed manually, automated by a machine. The entire processing of the shop computer 30 receiving the shop arrival notification, causing the products to be loaded, and transmitting the loading completion notification may be automated.

In a case in which the user purchases products at a plurality of shops, the vehicle 20 starts to drive again and travels to the next shop upon receiving the loading completion notification at the first shop. The processing illustrated in an area of FIG. 7 that is surrounded by a dash line is repeated for the number of shops where purchases have been made.

After passing through all the shops and loading the products, the vehicle 20 travels to a boarding location of the user in a case in which the boarding location is specified in the driving plan. At the boarding location, the vehicle 20 transmits, to the user terminal 40, a boarding waiting notification that indicates that the vehicle 20 is ready and waiting for the user to board, either via the information processing apparatus 10 or directly without using information processing apparatus 10.

Upon receiving the boarding waiting notification, the user boards the vehicle 20 that remains stationary, in a predetermined manner. For example, the vehicle 20 may be configured to unlock a door of the vehicle 20 in response to the user holding the user terminal 40 over a predetermined position on the vehicle 20. The vehicle 20 may determine whether the user is an authorized user based on the user identification information acquired from the user terminal 40. When the user has boarded the vehicle 20, the user terminal 40 may transmit, to the information processing apparatus 10, a boarding confirmation notification indicating that the user has boarded. The vehicle 20 may include a sensor that detects the boarding by the user, and start traveling to the destination when the user has boarded.

Upon arrival at the destination, the vehicle 20 stops in order for the user to unload the products from the vehicle 20. The vehicle 20 may transmit, to the information processing apparatus 10, a delivery finish notification indicating that the delivery has been finished.

### Processing Flow in Information Processing Apparatus

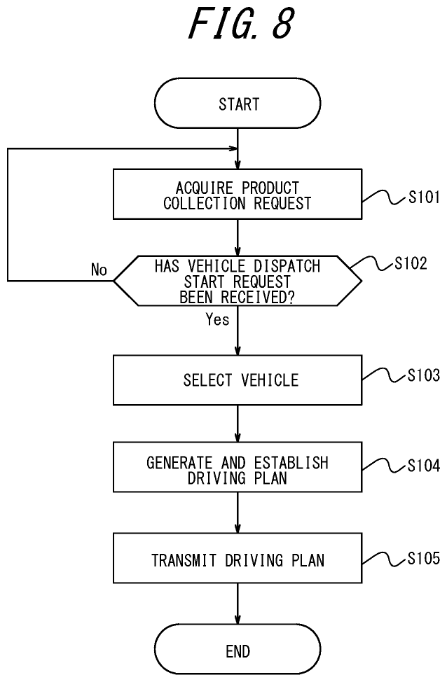

FIG. 8 is a flowchart that corresponds to the sequence diagrams of FIG. 5 and FIG. 7 and that illustrates the procedure of a vehicle dispatch processing method performed by the information processing apparatus 10.

The information processing apparatus 10 acquires, from a shop computer 30, a product collection request including user identification information and shop identification information (Step S101).

The information processing apparatus 10 can repeatedly acquire product collection requests before receiving the vehicle dispatch start request (Step S102: No). Upon receiving the vehicle dispatch start request (Step S102: Yes), the information processing apparatus 10 proceeds to processing of Step 5103.

In Step S103, the information processing apparatus 10 selects a vehicle 20 for collecting products.

In Step S104, based on the user identification information and the shop identification information included in the product collection requests, the information processing apparatus 10 generates and establishes a driving plan that specifies a driving route passing through each shop.

In Step S105, the information processing apparatus 10 transmits the established driving plan to the selected vehicle 20.

### Flow of Information in Vehicle Dispatch System in Which Vehicle is Dispatched Before Purchase of Products is Completed

In the processing flow in the vehicle dispatch system 1 described above, the information processing apparatus 10 generates the driving plan in response to the vehicle dispatch start request transmitted from the user terminal 40 by the user who has finished all the shopping. The vehicle 20 receives this driving plan before starting to collect the products. When, however, the collection of the products is started after the user finishes all the shopping, it may take time to collect the products by going through the plurality of shops and, in a case in which the user is to board the vehicle 20, the user may be left waiting for a long time. To avoid the above issue, when a predetermined condition is satisfied before the information processing apparatus 10 receives the vehicle dispatch start request from the user, the information processing apparatus 10 may generate and transmit an unestablished driving plan to the vehicle 20. This enables the vehicle 20 to start collecting the products.

The predetermined condition includes a case in which the user has purchased products at a predetermined number of shops. The predetermined number may be determined by considering a time period required for the vehicle 20 to collect the products and an allowable time period for which the user can wait for the vehicle 20. Further, the time of day may be considered as the predetermined condition. For example, at a late time in the afternoon, it can be estimated that the user is close to finishing shopping. The information processing apparatus 10 may estimate the shopping finish time from a past record of usage of the user. As the predetermined condition, distances between the shops at which the user has purchased products, and a distance between each shop and a current location of the user may be considered. Information regarding the current location of the user may be acquired from the user terminal 40. When estimating that the driving distance of the vehicle 20 after receiving the vehicle dispatch start request is to be equal to or greater than a predetermined distance, the information processing apparatus 10 may allocate the vehicle 20 before receiving the vehicle dispatch start request so as to start the collection of the products from the shops. The predetermined condition may include various other conditions.

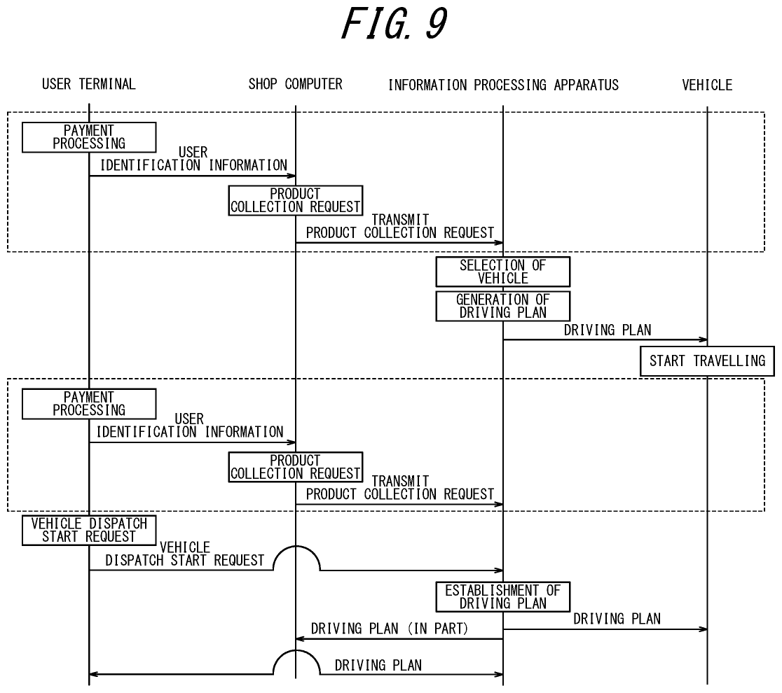

FIG. 9 illustrates an example flow of information between the components that occurs from purchase of products by the user to generation of a driving plan by the information processing apparatus 10 in a case in which the vehicle 20 is dispatched before the purchase of the products is finished.

Dash-line boxes each represent processing that starts to be executed when the user makes a payment associated with the purchase of any product. This processing is the same as the processing represented by the dash-line box of FIG. 5. The processing represented by each dash-line box may be repeated a plurality of times.

Unlike the sequence diagram illustrated in FIG. 5, in FIG. 9, when the predetermined condition is satisfied before the purchase of the products is finished, the information processing apparatus 10 executes the selection of the vehicle 20 and the generation of the driving plan. The selection of the vehicle 20 and the generation of the driving plan are executed based on the user identification information, the shop identification information of shops at which the user has purchased products up to that point, and the product information. Since the user has not finished shopping, the driving plan at this point is in an unestablished state.

The information processing apparatus 10 transmits, to the vehicle 20, the driving plan that has been generated. Upon acquiring the driving plan, the vehicle 20 starts to travel so as to collect the products in accordance with the driving plan. At this point onwards, when the user purchases one or more products at a shop and the information processing apparatus 10 receives a product collection request, the information processing apparatus 10 may update the driving plan in accordance with the received product collection request. The information processing apparatus 10 updates the driving plan, taking into account the products already collected by the vehicle 20 and information such as the current location of the vehicle 20. The information processing apparatus 10 may sequentially transmit the updated driving plan to the vehicle 20.

When finishing shopping, the user transmits the vehicle dispatch start request to the information processing apparatus 10 using the user terminal 40. Upon receiving the vehicle dispatch start request, the information processing apparatus 10 updates and establishes the driving plan, based on information regarding the content of the product collection requests received so far, a status of collection of products by the vehicle 20, the current location of the vehicle 20, and the like. The information processing apparatus 10 transmits the established driving plan to the vehicle 20. The vehicle 20 continues to drive in accordance with the established driving plan. As is the case with FIG. 5, the information processing apparatus 10 may transmit the driving plan to the shop computers 30 and the user terminal 40.

In a case in which the vehicle 20 starts collecting products before the user finishes shopping, the information processing apparatus 10 may add a vehicle 20 based on the product information received from the shop computers 30. For example, when the quantity of products that has been purchased by the user becomes too large to be loaded into the firstly selected vehicle 20, the information processing apparatus 10 may select the second vehicle 20 to collect some of the products. Hereafter, the flow of information between the components at the time of collecting the products is similar to that illustrated in FIG. 7, and therefore a description thereof will be omitted.

### Processing Flow in Information Processing Apparatus

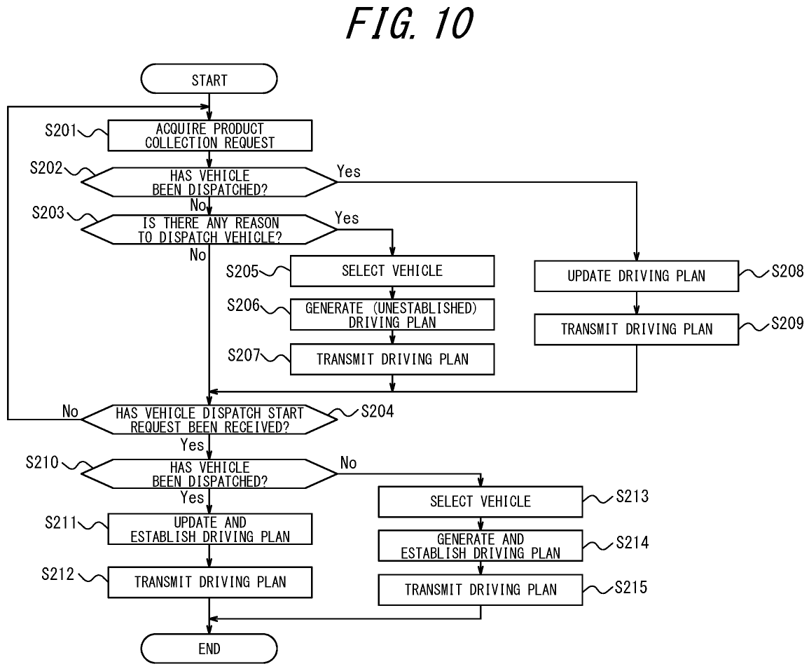

FIG. 10 is a flowchart that corresponds to the sequence diagram of FIG. 9 and that illustrates the procedure of a vehicle dispatch processing method performed by the information processing apparatus 10. The processing performed by the information processing apparatus 10 will be described in sequence below.

The information processing apparatus 10 acquires, from a shop computer 30, a product collection request including user identification information and shop identification information (Step S201).

In Step S202, when a vehicle 20 has not been dispatched yet for collecting the products purchased by the user (Step S202: No), the information processing apparatus 10 proceeds to Step S203.

In Step S203, the information processing apparatus 10 checks whether the predetermined condition for starting the collection of the products is satisfied. If the predetermined condition is not satisfied (Step S203: No), there is no reason to dispatch a vehicle 20, and so the processing of the information processing apparatus 10 proceeds to Step S204.

When the information processing apparatus 10 has not received the vehicle dispatch start request from the user terminal 40 (Step S204: No), the information processing apparatus 10 can return to Step S201 and acquire a product collection request again.

In Step S203, when the predetermined condition is satisfied (Step S203: Yes), the processing of the information processing apparatus 10 proceeds to Step S205.

In Step S205, the information processing apparatus 10 selects a vehicle 20 that is to collect the products purchased by the user, based on the product collection requests acquired up to that point.

Subsequent to Step S205, the information processing apparatus 10 generates an unestablished driving plan (Step S206).

Subsequent to Step S206, the information processing apparatus 10 transmits the generated driving plan to the selected vehicle 20 (Step S207). This enables the vehicle 20 to start collecting the products purchased by the user.

Subsequent to Step S207, when the information processing apparatus 10 has not received the vehicle dispatch start request (Step S204: No), the processing of the information processing apparatus 10 returns to Step S201 again, and a product collection request can be newly acquired.

In Step S202, when the unestablished driving plan has been already generated and when the vehicle 20 has been dispatched for collecting the products (Step S202: Yes), the information processing apparatus 10 updates the driving plan based on the newly acquired product collection request (Step S208).

Subsequent to Step S208, the information processing apparatus 10 transmits the updated driving plan to the vehicle 20 which is collecting the products purchased by the user (Step S209). This enables the vehicle 20 to continue to collect products based on the updated driving plan.

Subsequent to Step S203, Step S207, or Step S209, when the information processing apparatus 10 has received the vehicle dispatch start request (Step S204: Yes), the information processing apparatus 10 proceeds to processing of Step S210.

In Step S210, when the vehicle 20 has already been dispatched (Step S210: Yes), the information processing apparatus 10 updates and establishes the driving plan, based on all the product collection requests and, in a case in which the user is to board, the boarding location information (Step S211).

Subsequent to Step S211, the information processing apparatus 10 transmits the established driving plan to the vehicle 20 (Step S212).

When the vehicle 20 has not been dispatched yet in Step S210 (Step S210: No), the information processing apparatus 10 executes the processing similar to Step S103 through Step S105 of FIG. 8. That is, the information processing apparatus 10 selects the vehicle 20 for collecting the products (Step S213), generates and establishes the driving plan (Step S214), and transmits the established driving plan to the selected vehicle 20 (Step S215).

Subsequent to Step S212 or Step S215, the vehicle 20 collects all the products and drives to the destination in accordance with the driving plan. When requested by the user, the vehicle 20 loads the user and drives to the destination.

As has been described, according to the present embodiment, the information processing apparatus 10 acquires a product collection request corresponding to product purchase by the user and generates a driving plan, and a vehicle 20 capable of autonomous driving collects products by passing through shops at which the user has purchased the products in accordance with the driving plan. Thus, the vehicle dispatch system 1 can collect the products purchased by the user while flexibly addressing purchase behavior of the user. Further, the user does not need to carry the purchased products and can freely enjoy shopping. Another advantage is that, because the vehicle 20 carries the purchased products to a destination for the user as the user finishes shopping, there is no waiting time period for the products to be delivered that accompanies the use of ordinary product delivery services. Moreover, because the user can select to board the vehicle 20 loaded with the products, the user can secure a means of transport after finishing their shopping. In particular, by starting collection of the products that have been purchased while the user is purchasing products as illustrated in FIG. 9, the waiting time period for the user before boarding the vehicle 20 can be reduced.

It should be noted that the present disclosure is not limited to the above embodiment, and various modifications and revisions can be implemented. For example, functions or the like included in each means, each step, or the like can be rearranged without logical inconsistency, and a plurality of means, steps, or the like can be combined together or divided. The methods disclosed herein can be performed by a processor included in the information processing apparatus according to programs. Such programs can be stored in a non-transitory computer readable medium. These are also encompassed within the scope of the present disclosure.

1. A vehicle dispatch system comprising:
a plurality of vehicles configured to drive autonomously in accordance with a driving plan; and
an information processing apparatus configured to acquire a product collection request including user identification information and shop identification information to generate the driving plan based on the user identification information and the shop identification information, the user identification information identifying a user, the shop identification information identifying at least one shop at which the user has purchased a product, and the driving plan specifying a driving route passing through the at least one shop at which the user has purchased the product, wherein
upon receiving a vehicle dispatch start request, the information processing apparatus establishes the driving plan and transmits the driving plan to a selected vehicle that is selected from the plurality of vehicles.

2. The vehicle dispatch system according to claim 1, wherein
the information processing apparatus is configured to acquire, along with the shop identification information, product information related to the product purchased by the user, and select the selected vehicle from the plurality of vehicles based on the product information.

3. The vehicle dispatch system according to claim 1, wherein
in establishment of the driving plan, the information processing apparatus is configured to select the driving route based on a driving distance, the driving route starting at a current location of the selected vehicle, passing through the at least one shop, and terminating at a predetermined destination corresponding to the user identification information.

4. The vehicle dispatch system according to claim 1, wherein
in establishment of the driving plan, the information processing apparatus is configured to select the driving route based on an estimated driving time period, the driving route starting at a current location of the selected vehicle, passing through the at least one shop, and terminating at a predetermined destination corresponding to the user identification information.

5. The vehicle dispatch system according to claim 1, wherein
the information processing apparatus is configured to acquire, along with the vehicle dispatch start request, boarding location information indicating a boarding location at which the user is to board, and when acquiring the boarding location information, the information processing apparatus establishes the driving plan so as to include the boarding location in the driving route.

6. The vehicle dispatch system according to claim 1, further comprising
a shop computer used for sales processing for the product at the shop, wherein
the shop computer is configured to accept selection of delivery or pickup of the product, and when accepting the selection of delivery, the shop computer transmits the user identification information and the shop identification information to the information processing apparatus.

7. The vehicle dispatch system according to claim 6, wherein
the shop computer is configured to acquire, from the information processing apparatus, at least part of the driving plan for the selected vehicle that pertains to the product purchased at the shop.

8. The vehicle dispatch system according to claim 6, wherein
the shop computer is configured to acquire the user identification information from an information terminal in possession of the user.

9. The vehicle dispatch system according to claim 8, wherein
the shop computer is configured to perform payment processing for the product with the information terminal, and when the payment processing is completed, the shop computer transmits the product collection request to the information processing apparatus.

10. The vehicle dispatch system according to claim 8, wherein
the information processing apparatus is configured to acquire the user identification information from the shop computer and the information terminal, and collate the user identification information acquired from the shop computer with the user identification information acquired from the information terminal.

11. The vehicle dispatch system according to claim 6, wherein
when passing through the at least one shop in accordance with the driving plan, the selected vehicle remains stationary at the shop until the selected vehicle receives a loading completion notification indicating that loading of the product purchased by the user is completed.

12. The vehicle dispatch system according to claim 1, wherein
when a predetermined condition is satisfied before the information processing apparatus receives the vehicle dispatch start request, the information processing apparatus generates the driving plan, which is not yet established, transmits the driving plan to the selected vehicle, and establishes the driving plan upon receiving the vehicle dispatch start request.

13. An information processing apparatus comprising:
a communication interface configured to acquire a product collection request including user identification information and shop identification information, the user identification information identifying a user, and the shop identification information identifying at least one shop at which the user has purchased a product; and
a controller configured to generate a driving plan that specifies a driving route passing through the at least one shop at which the user has purchased the product based on the user identification information and the shop identification information, wherein
upon receiving a vehicle dispatch start request via the communication interface, the controller establishes the driving plan and transmits the driving plan via the communication interface to a selected vehicle that is selected from a plurality of vehicles configured to drive autonomously in accordance with the driving plan.

14. The information processing apparatus according to claim 13, wherein
the communication interface is configured to acquire, along with the shop identification information, product information related to the product purchased by the user, and the controller is configured to select the selected vehicle from the plurality of vehicles based on the product information.

15. The information processing apparatus according to claim 13, wherein
in establishment of the driving plan, the controller is configured to select the driving route based on a driving distance, the driving route starting at a current location of the selected vehicle, passing through the at least one shop, and terminating at a predetermined destination corresponding to the user identification information.

16. The information processing apparatus according to claim 13, wherein
in establishment of the driving plan, the controller is configured to select the driving route based on an estimated driving time period, the driving route starting at a current location of the selected vehicle, passing through the at least one shop, and terminating at a predetermined destination corresponding to the user identification information.

17. A vehicle dispatch processing method comprising:
acquiring a product collection request including user identification information and shop identification information, the user identification information identifying a user, and the shop identification information identifying at least one shop at which the user has purchased a product; and
generating a driving plan that specifies a driving route passing through the at least one shop at which the user has purchased the product based on the user identification information and the shop identification information; and
upon receiving a vehicle dispatch start request, establishing the driving plan and transmitting the driving plan to a selected vehicle that is selected from a plurality of vehicles configured to drive autonomously in accordance with the driving plan.

18. The vehicle dispatch processing method according to claim 17, comprising
acquiring, along with the shop identification information, product information related to the product purchased by the user, and selecting the selected vehicle from the plurality of vehicles based on the product information.

19. The vehicle dispatch processing method according to claim 17, wherein
the establishing of the driving plan includes selecting the driving route based on a driving distance, the driving route starting at a current location of the selected vehicle, passing through the at least one shop, and terminating at a predetermined destination corresponding to the user identification information.

20. The vehicle dispatch processing method according to claim 17, wherein
the establishing of the driving plan includes selecting the driving route based on an estimated driving time period, the driving route starting at a current location of the selected vehicle, passing through the at least one shop, and terminating at a predetermined destination corresponding to the user identification information.
